(19) United States
(12) Patent Application Publication
(10) Pub. No.: US 2018/0183224 A1
(43) Pub. Date: Jun. 28, 2018

(54) WIRE HARNESS

(71) Applicant: Sumitomo Wiring Systems, Ltd., Yokkaichi (JP)

(72) Inventor: Yuya HIROMORI, Yokkaichi (JP)

(21) Appl. No.: 15/838,587

(22) Filed: Dec. 12, 2017

(30) Foreign Application Priority Data
Dec. 27, 2016 (JP) 2016-254072

(51) Int. Cl. H02G 3/04; H01B 7/00

(52) U.S. Cl. CPC H02G 3/0481; B60R 16/0215; H01B 7/0045

(57) ABSTRACT

A wire harness that inhibits the movement of a wire relative to a pipe. A wire harness includes a wire, a pipe including a pipe body that covers the wire, and an extension portion extending from an end face of the pipe body in a longitudinal direction of the pipe body, and a holding portion that binds together a pulled-out portion of the wire that is pulled out from the pipe body and the extension portion.

### CROSS REFERENCE TO RELATED APPLICATIONS

This application claims the priority of Japanese patent application JP2016-254072 filed on Dec. 27, 2016, the entire contents of which are incorporated herein.

### TECHNICAL FIELD

The present invention relates to a wire harness.

### BACKGROUND ART

A wire harness that electrically connects a battery to an inverter in a vehicle such as an electric car or a hybrid car is known. This wire harness is routed, for example, underneath the floor of the vehicle, or the like. The wire harness includes a plurality of wires, and a pipe that covers the plurality of wires. The plurality of wires are pulled out from a distal end of the pipe to the outside, and are connected to a device such as an inverter. JP 2013-67292A discloses an example of a conventional wire harness.

JP 2013-67292A is an example of related art.

### SUMMARY

The length of the plurality of wires pulled out from the distal end of the pipe (hereinafter referred to as a “pulled-out length”) is set to a predetermined pulled-out length based on the distance relationship between the distal end of the pipe and the device such as an inverter. Meanwhile, during a subsequent process in which the plurality of wires are inserted into the pipe so as to have the predetermined pulled-out length, the wire harness is bent to route the wire harness, for example, underneath the floor of the vehicle. Accordingly, the plurality of wires may be pulled into the pipe as a result of the wire harness being bent, thus changing the pulled-out length.

The present design has been made in order to solve the above-described problem, and it is an object of the design to provide a wire harness that inhibits the movement of the wires relative to the pipe.

The wire harness that solves the above-described problem includes a wire; a pipe including a pipe body that covers the wire, and an extension portion extending from an end face of the pipe body in a longitudinal direction of the pipe body; and a holding portion that binds together a pulled-out portion of the wire pulled out from the pipe body and the extension portion.

With this configuration, the movement of the wire relative to the pipe is inhibited by the holding portion, thus making the wire less likely to move relative to the pipe even when the wire harness is bent during a subsequent process in which the wire is inserted into the pipe.

Preferably, the above-described wire harness further includes a restricting portion that is provided in the extension portion, and restricts movement of the holding portion relative to the pipe in the longitudinal direction of the pipe.

This configuration stabilizes the holding of the pulled-out portion by the holding portion, thus further inhibiting the movement of the wire relative to the pipe.

In the above-described wire harness, it is preferable that the extension portion has a shape of a semi-circular or substantially semi-circular arc as viewed in a cross section along a radial direction of the pipe.

With this configuration, the holding of the pulled-out portion by the holding portion can be easily stabilized even when the number of wires inserted into the pipe is large.

In the above-described wire harness, it is preferable that the pipe includes an inner layer made of a resin material, an intermediate layer that covers a surface of the inner layer and is made of a metal material, and an outer layer that covers a surface of the intermediate layer and is made of a resin material.

With this configuration, the inner circumferential surface of the pipe is constituted by the inner circumferential surface of the inner layer made of a resin material, thus reducing the possibility that the wire may be degraded by contact between the inner circumferential surface of the pipe and the wire.

In the above-described wire harness, it is preferable that the extension portion is constituted by a part of the inner layer, and the outer layer and the intermediate layer are removed such that the part of the inner layer is not covered by the outer layer and the intermediate layer.

With this configuration, no stepped portion is formed between the pipe body and the extension portion on the inner circumferential surface of the pipe, and therefore, any load resulting from contact between the wire and the stepped portion will not be applied to the wire.

With the wire harness according to the present design, the movement of the wire relative to the pipe is inhibited.

### BRIEF DESCRIPTION OF THE DRAWINGS

FIG. 1 is a schematic diagram showing an example of the routing state of a wire harness according to an embodiment;

FIG. 2 is a perspective view of the wire harness shown in FIG. 1;

FIG. 3 is a cross-sectional view of the wire harness shown in FIG. 1; and

FIG. 4 is a cross-sectional view taken along the line D4-D4 in FIG. 2.

### EMBODIMENTS

Hereinafter, a wire harness according to an embodiment will be described.

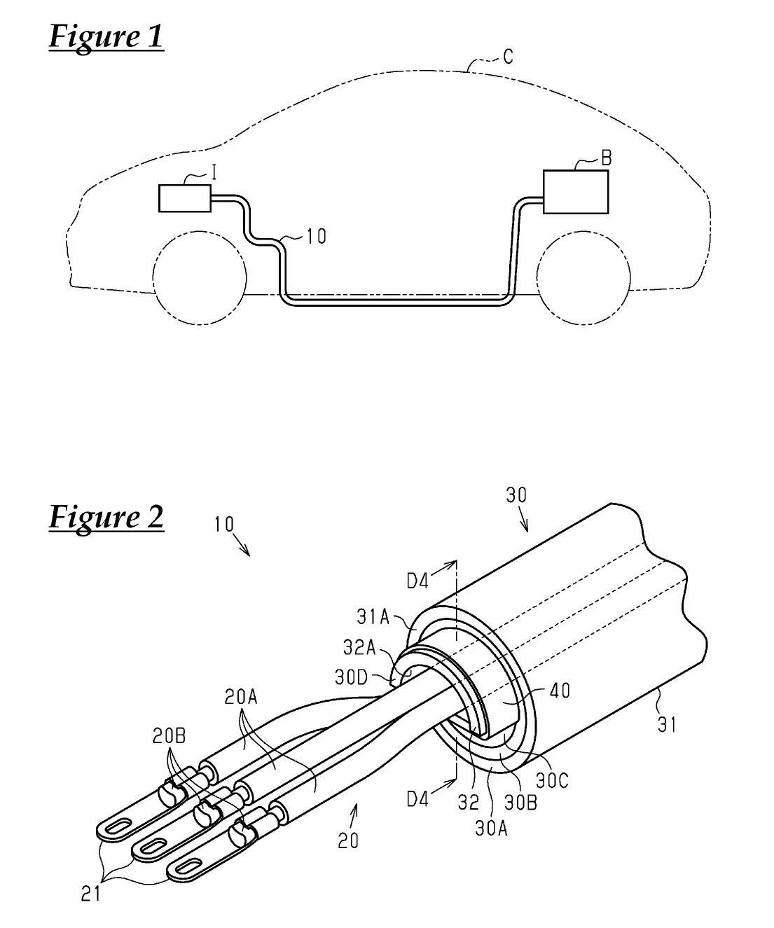

A vehicle C as shown in FIG. 1 includes a wire harness 10 that electrically connects a battery B and an inverter I. The battery B is mounted at the rear of the vehicle C, for example. The inverter I is mounted in an engine room located at the front of the vehicle C, for example. An example of the vehicle C is an electric car, a hybrid car, or the like. The wire harness 10 is routed so as to pass underneath the floor of the vehicle C, and is bent such that the battery B and the inverter I can be connected.

As shown in FIG. 2, the wire harness 10 includes wires 20 and a pipe 30 through which the wires 20 are inserted. The number of wires 20 is three, for example. The wire harness 10 further includes a terminal 21 provided at a distal end 20B of each of the wires 20. The wires 20 are pulled out from a distal end 30D of the pipe 30 to the outside, and are connected to a target device via the terminals 21. The target device is the battery B or the inverter I (see FIG. 1).

The pipe 30 is a pipe with a three-layer structure including an outer layer 30A, an intermediate layer 30B, and an inner layer 30C. An example of the material constituting the inner layer 30C is a resin material. The intermediate layer 30B covers the surface of the inner layer 30C, and is provided between the outer layer 30A and the inner layer 30C. An example of the material constituting the intermediate layer 30B is a metal material. An example of the metal material is aluminum. The outer layer 30A covers the surface of the intermediate layer 30B. An example of the material constituting the outer layer 30A is a resin material.

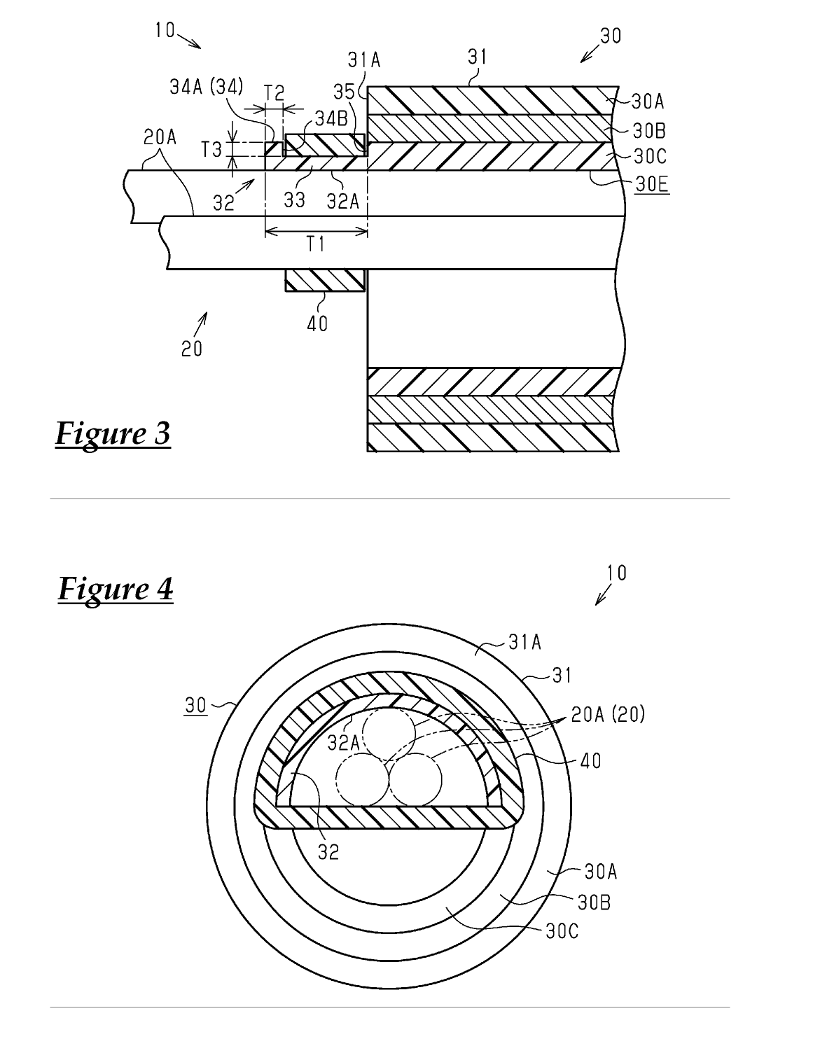

The pipe 30 includes a pipe body 31 that covers the wires 20, and an extension portion 32 extending from an end face 31A of the pipe body 31 in a longitudinal direction of the pipe body 31. The extension portion 32 is formed, for example, by removing a part of the pipe 30 at the distal end 30D of the pipe 30. An example of the method of removing a part of the pipe 30 is cutting. In an example, a portion having a predetermined length in the longitudinal direction of the pipe 30, and corresponding to approximately half the pipe 30 in the circumferential direction is removed from the extension portion 32 at the distal end 30D of the pipe 30. Next, the outer layer 30A and the intermediate layer 30B are removed from the extension portion 32 such that the extension portion 32 is not covered by the outer layer 30A and the intermediate layer 30B of the pipe 30. Accordingly, the extension portion 32 is constituted by a part of the inner layer 30C of the pipe 30. Since the extension portion 32 is constituted by a part of the inner layer 30C extending from the end face 31A of the pipe body 31, no stepped portion is formed between the pipe body 31 and the extension portion 32 on the inner circumferential surface 30E of the pipe 30 (see FIG. 3). The inner circumferential surface 30E of the pipe 30 is constituted by the inner circumferential surface of the inner layer 30C. In the example shown in FIG. 4, the extension portion 32 has the shape of a semi-circular or substantially semi-circular arc as viewed in a cross section along the radial direction of the pipe 30.

As shown in FIG. 2, the wire harness 10 further includes a holding portion 40 that binds together pulled-out portions 20A of the wires 20 that are pulled out from the pipe body 31 and the extension portion 32. An example of the holding portion 40 is tape that can be wound around the wires 20 and the extension portion 32. In an example, the holding portion 40 binds the pulled-out portions 20A and the extension portion 32 together such that the pulled-out portions 20A are pressed against the inner surface 32A of the extension portion 32. As a result of the holding portion 40 being wound around the pulled-out portions 20A and the extension portion 32 such that the pulled-out portions 20A and the extension portion 32 are bound together into a single bundle, the pulled-out portions 20A are held while being pressed against the inner surface 32A of the extension portion 32.

FIG. 3 shows a cross section of the wire harness 10 along the longitudinal direction. The extension portion 32 includes a support portion 33 extending from the end face 31A of the pipe body 31, and a restricting portion 34 that restricts the movement of the holding portion 40 relative to the pipe 30 in the longitudinal direction of the pipe 30. The restricting portion 34 includes a rib 34A that stands upright from the support portion 33 in the radial direction of the pipe 30. The rib 34A has the shape of a semi-circular or substantially semi-circular arc as viewed in a cross section along the radial direction of the pipe 30. The rib 34A includes a restricting surface 34B that restricts the movement of the holding portion 40 relative to the pipe 30 by coming into contact with the holding portion 40. In the example shown in FIG. 3, the angle of the restricting surface 34B relative to the support portion 33 is a right angle.

The extension portion 32 further includes a groove 35 that is surrounded by the end face 31A of the pipe body 31, the support portion 33, and the restricting surface 34B of the rib 34A in the longitudinal direction of the pipe 30. In an example, the restricting portion 34 and the groove 35 are formed by removing a part of the extension portion 32. An example of the method for removing a part of the extension portion 32 is cutting. The holding portion 40 is wound along the groove 35 such that the pulled-out portions 20A and the extension portion 32 are bound together into a single bundle. Accordingly, the movement of the holding portion 40 relative to the pipe 30 is restricted by the restricting surface 34B and the end face 31A of the pipe body 31 in the longitudinal direction of the pipe 30.

An example of the preferred range for a length T1 of the extension portion 32 in the longitudinal direction of the pipe 30 is 20.0 to 30.0 mm. In an example, the length T1 of the extension portion 32 is 25.0 mm. An example of the preferred range for a length T2 of the rib 34A in the longitudinal direction of the pipe 30 is 3.0 to 7.0 mm. In an example, the length T2 of the rib 34A is 5.0 mm. An example of the preferred range for a height T3 of the restricting surface 34B in the radial direction of the pipe 30 is 0.5 to 1.5 mm. In an example, the height T3 of the restricting surface 34B is 1.0 mm.

As shown in FIG. 4, as a result of the pulled-out portions 20A and the extension portion 32 being bound together by the holding portion 40, the pulled-out portions 20A are held by the holding portion 40 while being pressed against the inner surface 32A of the extension portion 32. The movement of the wires 20 in the longitudinal direction of the pipe 30 is restricted by the friction caused by the force of pressing the pulled-out portions 20A against the inner surface 32A of the extension portion 32 by the holding portion 40, and the adhesion force of the holding portion 40. The adhesion force of the holding portion 40 is exerted when the holding portion 40 has an adhesion force. The movement of the wires 20 in a direction away from the inner surface 32A of the extension portion 32 is restricted by the contact with the holding portion 40.

A procedure for routing the wire harness 10 will be described with reference to FIGS. 1 to 4.

The wire harness 10 is routed in the vehicle C, for example, using the following routing procedures. In the first procedure, the wires 20 are inserted into the pipe 30 such that the pulled-out portions 20A of the wires 20 are pulled out from the pipe body 31 (see FIG. 2). In the first procedure, the length of the pulled-out portions 20A that are pulled out from the pipe body 31 (hereinafter referred to as a “pulled-out length”) is set to be a predetermined pulled-out length based on the distance relationship between the end face 31A of the pipe body 31 and the target device. In the second procedure, the pulled-out portions 20A and the extension portion 32 are bound together by the holding portion 40 such that the pulled-out portions 20A are pressed against the inner surface 32A of the extension portion 32 (see FIG. 4).

In the third procedure, the wire harness 10 is bent to route the wire harness 10 underneath the floor of the vehicle C (see FIG. 1). A force that pulls the wires 20 into the pipe 30 is exerted as a result of the wire harness 10 being bent in the third procedure. Meanwhile, since the pulled-out portions 20A are held by the holding portion 40 while being pressed against the inner surface 32A of the extension portion 32, the movement of the wires 20 relative to the pipe 30 is inhibited. This reduces the likelihood that the pulled-out length will change as a result of the wire harness 10 being bent.

In the fourth procedure, a braided wire is attached to the pipe 30 such that the pulled-out portions 20A are inserted into the braided wire (not shown). The braided wire is formed, for example, by braiding a plurality of bare metal element wires into a tubular shape. In the fifth procedure, the terminals 21 of the wires 20 are connected to the target device. Through the above-described routing procedures, the wire harness 10 is routed in the vehicle C.

According to the present embodiment, the following effects can be achieved.

The pulled-out portions 20A of the wires 20 and the extension portion 32 are bound together by the holding portion 40. With this configuration, movement of the wires 20 relative to the pipe 30 is inhibited by the holding portion 40, and therefore, the wires 20 are less likely to move relative to the pipe 30 even when the wire harness 10 is bent during a subsequent process in which the wires 20 are inserted into the pipe 30. This reduces the likelihood that the pulled-out length will change due to the wire harness 10 being bent. Accordingly, it is possible to suppress variations in the pulled-out length, making it possible to maintain high dimensional accuracy. Additionally, the pulled-out portions 20A and the extension portion 32 are bound together by the holding portion 40 such that the pulled-out portions 20A of the wires 20 are pressed against the inner surface 32A of the extension portion 32, thus further inhibiting the movement of the wires 20 in the longitudinal direction of the pipe 30.

The movement of the holding portion 40 relative to the pipe 30 in the longitudinal direction of the pipe 30 is restricted by the restricting surface 34B of the restricting portion 34 and the end face 31A of the pipe body 31. With this configuration, the holding of the pulled-out portions 20A by the holding portion 40 is stabilized, thus further inhibiting the movement of the wires 20 relative to the pipe 30.

The extension portion 32 has the shape of a semi-circular or substantially semi-circular arc as viewed in a cross section in the radial direction of the pipe 30. With this configuration, the holding of the pulled-out portions 20A by the holding portion 40 can be easily stabilized even when the number of wires 20 inserted into the pipe 30 is large.

The pipe 30 is a pipe having a three-layer structure including the outer layer 30A, the intermediate layer 30B, and the inner layer 30C. The inner circumferential surface 30E of the pipe 30 is constituted by the inner circumferential surface of the inner layer 30C made of a resin material. This reduces the likelihood of the wires 20 being degraded through contact between the inner circumferential surface 30E of the pipe 30 and the wires 20.

The extension portion 32 is constituted by a part of the inner layer 30C of the pipe 30. With this configuration, no stepped portion is formed between the pipe body 31 and the extension portion 32 on the inner circumferential surface 30E of the pipe 30, and therefore, any load resulting from contact between the wires 20 and a stepped portion will not be applied to the wires 20.

With the wire harness 10, the movement of the wires 20 relative to the pipe 30 is inhibited by the pulled-out portions 20A and the extension portion 32 being bound together by the holding portion 40. Meanwhile, the extension portion 32 constitutes a part of the pipe 30. Accordingly, the number of components constituting the wire harness 10 is reduced as compared with a case where the extension portion 32 is a component separate from the pipe 30.

The above description of the embodiments shows merely exemplary forms that the wire harness according to the present invention may take, and is not intended to limit the invention to the exemplary forms. The present invention may take forms other than the above-described embodiments, including, for example, the following modifications of the embodiments, and forms in which at least two modifications that are not mutually inconsistent are combined.

The configuration of the extension portion 32 may be changed freely. In a first example, the extension portion 32 is constituted by a part of the outer layer 30A of the pipe 30. In a second example, the extension portion 32 is constituted by a part of the intermediate layer 30B of the pipe 30. In a third example, the extension portion 32 is constituted by a part of the intermediate layer 30B and a part of the inner layer 30C of the pipe 30. In a fourth example, the extension portion 32 is constituted by a part of the outer layer 30A and a part of the intermediate layer 30B of the pipe 30. In a fifth example, the extension portion 32 is constituted by a part of the outer layer 30A, a part of the intermediate layer 30B, and a part of the inner layer 30C of the pipe 30. In a sixth example, the extension portion 32 is constituted by a member separate from the pipe body 31.

The configuration of the pipe 30 can be changed freely. In an example, the pipe 30 is a metal pipe.

The configuration of the restricting portion 34 can be changed freely. In a first example, the restricting portion 34 is provided separately from the extension portion 32. In a second example, the restricting surface 34B is inclined relative to the support portion 33 such that the angle of the restricting surface 34B relative to the support portion 33 is an acute angle or an obtuse angle. In a third example, the restricting surface 34B is curved relative to the support portion 33.

The shape of the extension portion 32 as viewed in a cross section along the radial direction of the pipe 30 can be changed freely. In a first example, the extension portion 32 has the shape of an arc smaller than a semi-circular arc. In a second example, the extension portion 32 has the shape of an arc larger than a semi-circular arc. In a third example, the extension portion 32 has the shape of a circle. Preferably, the outer layer 30A and the intermediate layer 30B are removed from the extension portion 32 in the third example such that the extension portion 32 is not covered by the outer layer 30A and the intermediate layer 30B of the pipe 30. According to this example, the holding portion 40 is wound around portions of the pulled-out portions 20A that have been pulled out from the extension portion 32 and around the extension portion 32 such that the pulled-out portions 20A and the extension portion 32 are bound together. Note that a preferred shape of the extension portion 32 is determined based on the number of wires 20 and the thickness of the wires 20, for example.

The number of wires 20 can be changed freely. In an example, the number of the wires 20 is one, two, or four or more.

The configuration of the holding portion 40 can be changed freely. In an example, the holding portion 40 is a cable tie that can be wound around the wires 20 and the extension portion 32.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

10 Wire harness
20 Wire
20A Pulled-out portion
30 Pipe
30A Outer layer
30B Intermediate layer
30C Inner layer
31 Pipe body
31A End face
32 Extension portion
34 Restricting portion
40 Holding portion

What is claimed is:

1. A wire harness comprising:
a wire;
a pipe including a pipe body that covers the wire, and an extension portion extending from an end face of the pipe body in a longitudinal direction of the pipe body; and
a holding portion that binds together a pulled-out portion of the wire pulled out from the pipe body and the extension portion.

2. The wire harness according to claim 1, further comprising
a restricting portion that is provided in the extension portion, and restricts movement of the holding portion relative to the pipe in the longitudinal direction of the pipe.

3. The wire harness according to claim 1, wherein
the extension portion has a shape of a semi-circular or substantially semi-circular arc as viewed in a cross section along a radial direction of the pipe.

4. The wire harness according to claim 1, wherein
the pipe includes an inner layer made of a resin material, an intermediate layer that covers a surface of the inner layer and is made of a metal material, and an outer layer that covers a surface of the intermediate layer and is made of a resin material.

5. The wire harness according to claim 4, wherein
the extension portion is constituted by a part of the inner layer, and the outer layer and the intermediate layer are removed such that the part of the inner layer is not covered by the outer layer and the intermediate layer.
